(19) United States
(12) Patent Application Publication
(10) Pub. No.: US 2021/0183272 A1
(43) Pub. Date: Jun. 17, 2021

(54) PACKAGING LABELS WITH IMPROVED ADHESION PROFILE AND METHODS OF FORMING SAME

(71) Applicant: Merck Sharp & Dohme Corp., Rahway, NJ (US)

(72) Inventors: Johannes Cornelis Maria Mertens, Vinkel (NL); Ebuel Sirmats, Wittinsburg (CH); Jan Waal, Est (NL); Adrianus Hubertus Johannes Gertrudis Wijdeven, Uden (NL)

(21) Appl. No.: 17/116,496

(22) Filed: Dec. 9, 2020

Related U.S. Application Data
(60) Provisional application No. 62/947,854, filed on Dec. 13, 2019.

(51) Int. Cl. G09F 3/02; G09F 3/10

(52) U.S. Cl. CPC G09F 3/02; G09F 3/10; G09F 2003/0257; G09F 2003/0222; G09F 2003/021

(57) ABSTRACT

A label having a first end and a second end, and defining an overlapping segment adjacent the first end, a peel-off segment adjacent the second end, and a middle segment disposed between the overlapping segment and the peel-off segment, the label comprising a release lacquer disposed in at least the peel-off segment, the release lacquer being disposed in a shape and having at least one void having no lacquer formed within the shape, the at least one void being defined adjacent the second end of the label.

### CROSS-REFERENCE TO RELATED APPLICATIONS

The present application claims the benefit of U.S. Provisional Application No. 62/947,854 filed Dec. 13, 2019, incorporated herein by reference in its entirety.

### FIELD OF THE DISCLOSURE

The present disclosure relates generally to packaging labels. More specifically, the present disclosure relates to methods and systems for improving the adhesion profile of labels.

### BACKGROUND OF THE DISCLOSURE

Adherable labels are often used in packaging to provide information. This may include information intended to be read by the consumer or end user such as contents of the package, brand, trademark, tradenames, expiration dates, usage restrictions, ingredients, source and/or origin of goods. The label may also provide information to retailers (e.g., instructions to assist in storage or transportation of the package), or to some regulatory body. Such labels may be used on vials or bottles, such as medicament bottles, containers, boxes, cartons, paper products, bags, and the like.

Labels may be secured via adhesives, and in some instances, the labels may begin to unintentionally peel off a target location, or lose adhesion over time due to changes in temperature or moisture. This is also common with multi-layer labels of medicament bottles where the layers cease adhering together as intended. In addition to being unsightly, labels may include important information that are at a risk of being lost, which may pose a risk to the consumer. Thus, there exists a need for devices, methods and systems for improving adhesion profiles of labels on packaging.

### SUMMARY OF THE DISCLOSURE

In one aspect, the disclosure provides a label having a first end and a second end. The label comprises a release lacquer disposed adjacent the second end in a shape and having at least one void formed within the shape, the at least one void being defined adjacent the second end of the label.

In another aspect, the disclosure provides a label having a first end and a second end, the label defining an overlapping segment adjacent the first end, a peel-off segment adjacent the second end, and a middle segment disposed between the overlapping segment and the peel-off segment. The label comprises a release lacquer disposed in at least the peel-off segment, the release lacquer being disposed in a shape and having at least one void formed within the shape, the at least one void being defined adjacent the second end of the label.

In some embodiments of any of the foregoing aspects, the label further comprises a backing layer that extends across the overlapping segment, the middle segment, and the peel-off segment. In some embodiments, the label further comprises a first unit comprising an adhesive layer and a plastic film, the first unit extending across the overlapping segment, the middle segment, and the peel-off segment. In some embodiments, the label further comprises a second unit comprising an adhesive layer and a plastic film, the second unit extending across the overlapping segment, the middle segment, and the peel-off segment. In some embodiments, the label further comprises an ink layer disposed in at least the middle segment. In some embodiments, the label further comprises a neutralization layer disposed adjacent the second end of the label.

In some embodiments of any of the foregoing aspects, the at least one void comprises a single void. In some embodiments, the at least one void comprises a plurality of voids. In some embodiments, the at least one void comprises three voids.

In some embodiments of any of the foregoing aspects, each of the at least one void has a curved triangular shape, the curved triangular shape comprising two curved inner edges, and an outer edge. In some embodiments, the outer edge of the curved triangular shape is coterminous with the second end of the label.

In some embodiments of any of the foregoing aspects, a density of the at least one void decreases from the second end to the first end. In some embodiments, an area covered by the at least one void decreases from the second end to the first end. In some embodiments, the number of voids decreases from the second end to the first end.

### BRIEF DESCRIPTION OF THE DISCLOSURE

Various embodiments of the presently disclosed labels are disclosed herein with reference to the drawings, wherein:

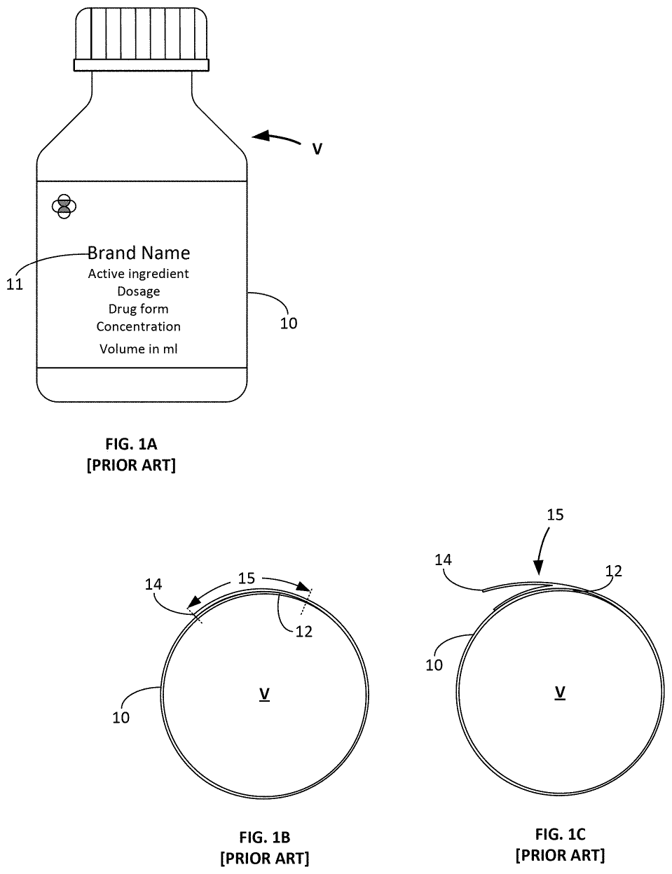

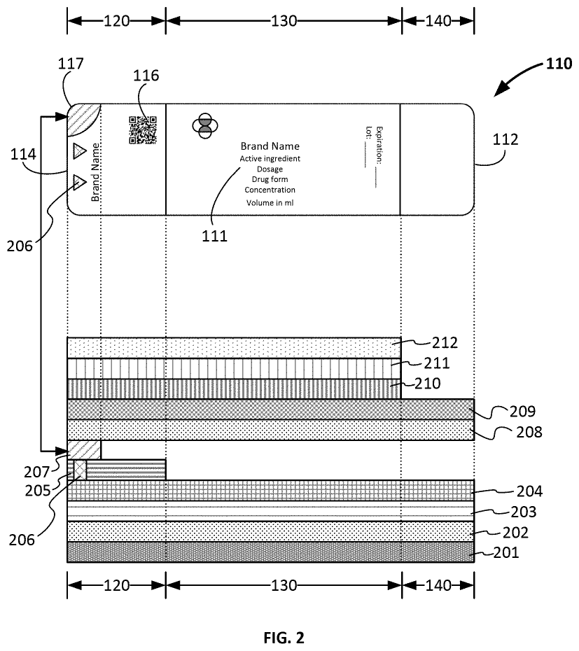

FIG. 1A is schematic side view of one example of a medicament bottle having a label;

FIGS. 1B-C are schematic transverse cross-sectional views of the bottle of FIG. 1A showing attachment of the label, and a label that has come loose, respectively;

FIG. 2 is a schematic illustration showing a top view of a label and a corresponding cross-sectional view showing the various layers of materials associated with each segment of the label according to one embodiment;

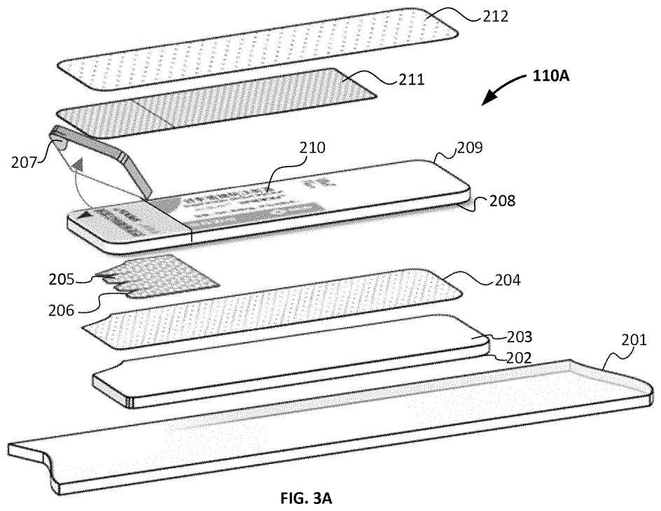

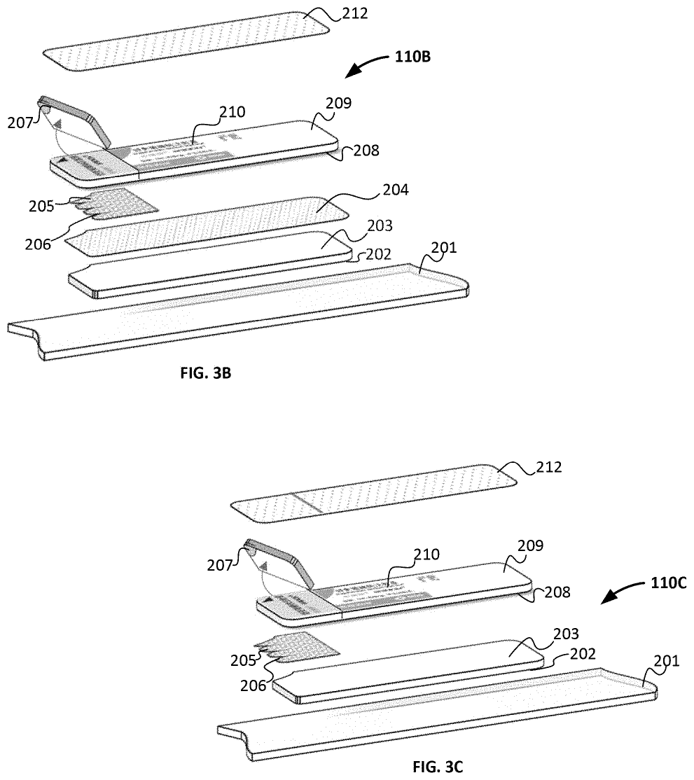

FIGS. 3A-C are schematic exploded perspective views of several embodiments of labels having various layers according to the disclosure; and

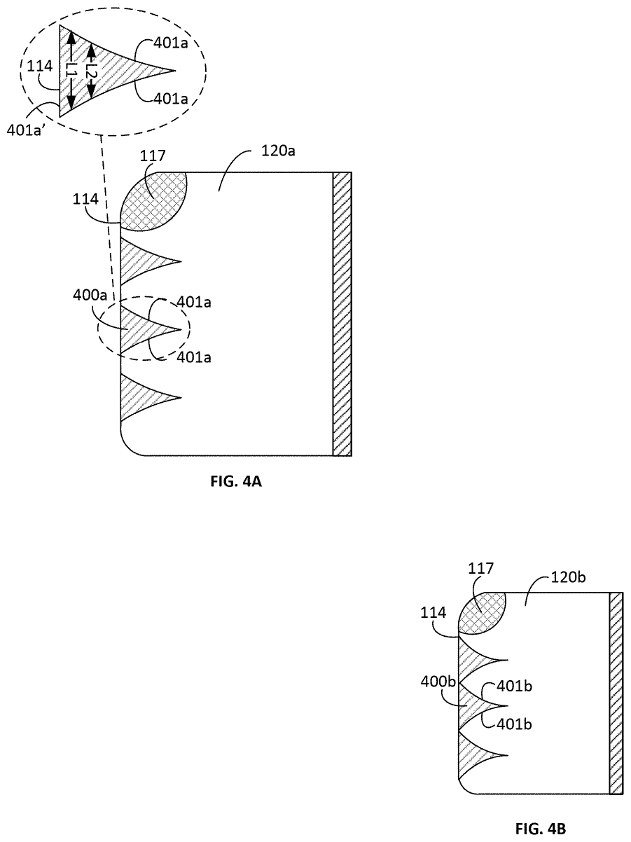

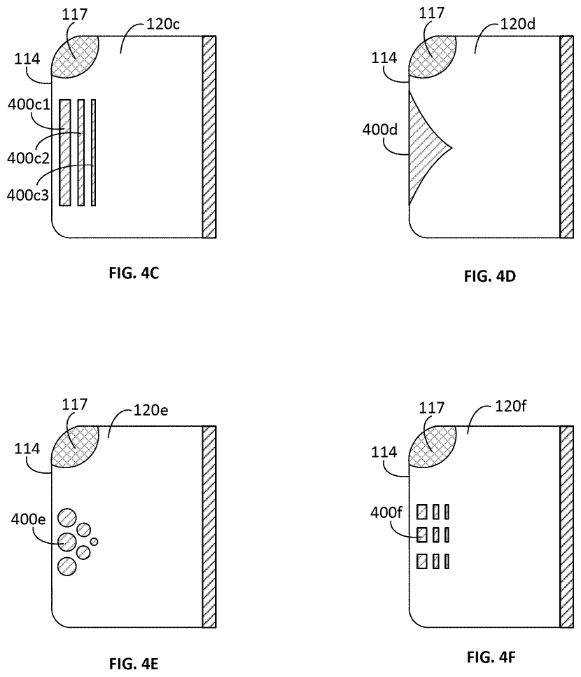

FIGS. 4A-F are schematic partial top views of various examples of labels according to embodiments of the present disclosure.

Various embodiments will now be described with reference to the appended drawings. It is to be appreciated that these drawings depict only some embodiments of the disclosure and are therefore not to be considered limiting of its scope.

### DETAILED DESCRIPTION

Despite the various improvements that have been made to packaging and labels, conventional methods suffer from some shortcomings as discussed above.

Therefore, there is a need for further improvements to the devices and methods used to help facilitate proper adhesion of a label to a package and/or to other layers of a label. Among other advantages, the present disclosure may address one or more of these needs.

Reference is now made to FIG. 1A, which shows a medicament bottle or vial “V” having a label 10 attached about its circumference. Label 10 may be adhered to the bottle and may include information 11 such as the brand name of the medicine, the active ingredient, dosage, drug form, concentration and/or volume of the medicament, as well as other identifying or factual information. Label 10 may include a single layer of material or multiple layers of material. As shown in FIG. 1B, label 10 may be wrapped around bottle “V” and adhered thereto, label 10 having a first end 12 and a second end 14. In one example, first end 12 of the label is adhered to the bottle, and the label may wrap around the perimeter of the bottle so that second end 14 passes over first end 12 and forms an overlapping portion 15. The extent to which the second end 14 forms an overlapping portion 15 may depend on the length of the label and the circumference of the bottle. As shown, only approximately 20% of the circumference includes an overlapping portion, although this may be adjusted as desired.

Providing overlapping portions and/or multiple layers may be desired in applications where a single layer would be insufficient to contain all the desired information. For example, medicament bottles may include dosing charts, possible side effects, warnings, and a host of other information that would not be possible to fit onto one side of a label. Thus, labels with multiple layers, and with writing on both sides of the label are possible, and such bottles may have peel-away segments to allow layers of the label to be pulled apart to reveal additional information when necessary, and to re-adhere together after the information is accessed.

As shown in FIG. 1C, a portion of the label adjacent second end 14 may lose adhesion and extend or bow away from the bottle. In this example, label 10 has multiple layers that no longer adhere together so that one or more of the layers flexes away from the other layers of the label. This phenomenon of the loss of adequate adhesion of a portion of a label, termed “flagging”, may be problematic in bottles having labels with peel-away segments. The following techniques and methods are contemplated in order to reduce the likelihood of flagging or loss of adhesion in parts of the label.

FIG. 2 illustrates an example of a label 110 according to one embodiment of the present disclosure. Label 110 may extend between ends 112 and 114 and be divided into three segments, including a peel-off segment 120 adjacent second end 114, an overlapping segment 140 adjacent first end 112, and a middle segment 130 between the peel-off segment and the overlapping segment. Each of these segments may include one or more layers of materials. Middle segment 130 may form approximately 50% or more of the length of the label. Middle segment 130 may include information 111 including any of the information described above (e.g., see paragraphs [2] and [20]). In some embodiments, label 110 is sized so that peel-off segment 120 overlaps with overlapping segment 140 and adheres thereto. Peel-off segment may include a QR code 116 that will, for example, direct a user to a website with additional information, and a peel-away corner 117 to aid in lifting peel-off segment 120 to separate certain layers from one another.

One embodiment of the various layers forming label 110 is also shown at the bottom of FIG. 2. For the sake of clarity, a number of layers are shown, the layers being presented as they correlate or correspond to the top view of the label above it. As shown, each of segments 120,130,140 may comprise one or multiple layers of material. For example, six layers of material are shown in overlapping segment 140. Additionally, a single layer of material may extend across one, two or all three segments of the label. Moreover, it will be understood that while one embodiment is shown in FIG. 2, the order, number, size and/or shape of the layers may be modified as desired.

Beginning at the bottom-most layer, a generally rectangular backing layer 201 may extend across all three segments 120,130,140. In at least some embodiments, backing layer 201 comprises a polyethylene terephthalate (PET) 30 μm TopC transparent material. A first adhesive layer 202 is disposed above backing layer 201 and may comprise, for example, a printable clear permanent acrylic adhesive such as FASSON S692NP. Adhesive layer 202 may serve to adhere backing layer 201 to a first film layer 203, which may comprise, for example, a transparent polypropylene film, such as a PP 50 TC Light Transparent material. Disposed above the first film layer 203 is a primer layer 204. In some embodiments, primer layer 204 is optional. In some embodiments, primer layer 204 extends all the way across the label from first end 112 to second end 114, or only partly across the label. As shown, each of these first four layers may extend from first end 112 to second end 114 across all three segments 120,130,140.

The next two layers may be disposed only in the peel-off segment 120, and may include a release lacquer layer 205 having one or more voids 206, and a neutralization layer 207. Release lacquer layer 205 may comprise a release lacquer and one or more voids 206, locations where the lacquer is not disposed. In at least some embodiments, the release lacquer is added (e.g., via printing or other depositing method) and voids are defined where no release lacquer is added. In at least some embodiments, the release lacquer is added as a complete layer and certain portions of the release lacquer are subtracted or removed to form the voids. In the top view, the locations of voids 206 are indicated by two triangular shapes adjacent second end 114. The voids 206 may take on a number of shapes, sizes and/or configurations as will be described below in greater detail. Neutralization layer 207 may be disposed in the corner of peel-off segment 120, for example, in the shape of a quadrant and may be used to allow peel-away corner 117 to easily release certain layers from primer layer 204.

A second adhesive layer 208 may extend across all three segments, and this second adhesive layer may comprise the same or a different adhesive than first adhesive layer 202. A second film layer 209 is disposed above the second adhesive layer 208, and may comprise a white polypropylene film such as PP 50 TC Top white. Second adhesive layer 208 and second film layer 209 may extend across all three segments. Finally, three layers may be disposed in only the peel-off segment 120 and middle segment 130, and they may include an ink layer 210, such as flexography or other printing ink, a luminescent varnish layer 211 and an imprint varnish layer 212.

In one embodiment, label 110 may be constructed to have a single adhesive layer, instead of multiple adhesive layers. In such single-layer adhesive embodiments, segment 120 may be a tear-off segment instead of a peel-off segment, separable from middle segment 130 by a perforation. In such embodiments, overlapping segment 140 may comprise release lacquer and one or more voids where the release lacquer is not disposed. When applying such a single-layer adhesive label to a vial, the tear-off section will overlap the overlap section.

To illustrate several variations, FIGS. 3A-C provide perspective exploded views of certain embodiments. In FIG. 3A, label 110A includes a backing layer 201, a first adhesive layer 202, a first film layer 203, a primer layer 204, and a release lacquer layer 205 having voids 206. Label 110A also includes a neutralization layer 207 in a corner of the label. A second adhesive layer 208 is disposed above the release lacquer layer 205 followed by a second film layer 209, an ink layer 210, a luminescent varnish layer 211 and an imprint varnish layer 212. In FIG. 3B, a second label 110B is shown which is similar to label 110A, except that it does not include a luminescent varnish layer 211. In FIG. 3C, a third label 110C is shown which is similar to labels 110A,110B except that it does not include a luminescent varnish layer 211 or a primer layer 204. It will be understood that combinations of these embodiments are possible and that other layers may be removed as desired.

FIGS. 4A-F illustrate several variations of peel-off segments 120a-f. As shown in FIG. 4A, in one embodiment, peel-off segment 120a includes a peel-away corner 117 and a number of voids arranged in a repeating pattern, each void 400a being in a curved triangular shape. Each curved triangular void 400a may be generally triangular, but have an outer edge 401a′ that is coterminous with the second end 114, and a curvature at two inner edges 401a. In the embodiment shown, three voids 400a are formed of equal size, the three voids being equally vertically distributed along second end 114. In some embodiments, the curved triangular void may be configured as an equilateral triangular void, an isosceles triangular void, a scalene triangular void, an acute triangular void, a right triangular void, or an obtuse triangular void. Additionally, it will be understood that due to the tapering of the inner edges, each void has a decreasing length as the shape extends away from the second end 114 (e.g., L1>L2). With reference to FIG. 3A, a majority (e.g., greater than 50%) of peel-off segment 120 may include contact between primer layer 204 and release lacquer layer 205. Stated another way, voids 400a may be disposed in less than 50% of peel-off segment 120. Because voids 400a have no release lacquer, second adhesive layer 208 may adhere directly to primer layer 204 through these voids. The curved triangular configuration shown in FIG. 4A provides a superior adhesion profile so that the portions of peel-off segment 120 can be easily removed from other portions and re-adhered when desired.

These and similar principles may be applied in other embodiments. For example, in one embodiment shown in FIG. 4B, the curved triangular-shaped voids 400b within peel-off segment 120b contact one another instead of being spaced apart, and the inner edges 401b are more curved than inner edges 401a of FIG. 4A. In peel-off segment 120c of FIG. 4C, one or more voids are formed as vertically-extending strips 400c1,400c2,400c3 of equal length that are spaced from one another. The strips 400c1,400c2,400c3 are of different widths, with the widest strip 400c1 (and thus the greatest adhesion) being closest to second end 114, and the narrowest strip 400c3 being farthest from the second end 114. It will be understood that a single strip or two strips of voids may be used instead of three. In peel-off segment 120d of FIG. 4D, a single large curved triangular void 400d is formed. In peel-off segment 120e of FIG. 4E, a plurality of circular voids 400e are formed in the release lacquer layer 205, the circular voids 400e being largest and/or more numerous adjacent the second end 114, and smallest and/or less numerous farthest from the second end 114. In peel-off segment 120f of FIG. 4F, a plurality of rectangular voids 400f arranged in rows and columns are formed in the release lacquer layer 205, the voids 400f being largest and/or more numerous adjacent the second end 114, and smallest and/or less numerous farthest from the second end 114. In at least some embodiments, the shape and/or size of the voids may be chosen as desired, and embodiments are contemplated where a mixture or combination of shapes and/or sizes of voids are formed on a same peel-off segment.

In some embodiments, the voids 400 may cover an area of the peel-off segment 120 and the area covered by the voids may decrease from one end to the other. As used herein, the term “density” when applied to voids is defined as the total area defined by voids over a total area of the peel-off segment 120. In at least some embodiments, the voids will be formed to have a greatest density adjacent second end 114, and a smallest density farthest from the second end. The density of the voids may gradually decrease, linearly or non-linearly (e.g., parabolically), from the second end 114 toward first end 112. In at least some embodiments, all or most of the voids are formed closer to second end 114 than middle segment 130.

It is to be understood that the embodiments described herein are merely illustrative of the principles and applications of the present disclosure. For example, the total number, locations, shapes and/or arrangement of voids may be varied. Moreover, certain components are optional, and the disclosure contemplates various configurations and combinations of the elements disclosed herein. It is therefore to be understood that numerous modifications may be made to the illustrative embodiments and that other arrangements may be devised without departing from the spirit and scope of the present disclosure as defined by the appended claims.

It will be appreciated that the various dependent claims and the features set forth therein can be combined in different ways than presented in the initial claims. It will also be appreciated that the features described in connection with individual embodiments may be shared with others of the described embodiments.

1. A label having a first end and a second end, the label comprising:
a release lacquer disposed adjacent the second end in a shape and having at least one void formed within the shape, the at least one void being defined adjacent the second end of the label.

2. The label of claim 1, wherein the at least one void comprises a single void.

3. The label of claim 1, wherein the at least one void comprises a plurality of voids.

4. The label of claim 3, wherein the at least one void comprises three voids.

5. The label of claim 1, wherein each of the at least one void has a curved triangular shape, the curved triangular shape comprising two curved inner edges, and an outer edge.

6. The label of claim 5, wherein the outer edge of the curved triangular shape is coterminous with the second end of the label.

7. The label of claim 1, wherein a density of the at least one void decreases from the second end to the first end.

8. The label of claim 1, wherein an area covered by the at least one void decreases from the second end to the first end.

9. The label of claim 1, wherein the number of voids decreases from the second end to the first end.

10. The label of claim 1, further comprising a neutralization layer disposed adjacent the second end of the label.

11. A label having a first end and a second end, the label defining an overlapping segment adjacent the first end, a peel-off segment adjacent the second end, and a middle segment disposed between the overlapping segment and the peel-off segment, the label comprising: a release lacquer disposed in at least the peel-off segment, the release lacquer being disposed in a shape and having at least one void formed within the shape, the at least one void being defined adjacent the second end of the label.

12. The label of claim 11, further comprising a backing layer that extends across the overlapping segment, the middle segment, and the peel-off segment.

13. The label of claim 12, further comprising a first unit comprising an adhesive layer and a plastic film, the first unit extending across the overlapping segment, the middle segment, and the peel-off segment.

14. The label of claim 13, further comprising a second unit comprising an adhesive layer and a plastic film, the second unit extending across the overlapping segment, the middle segment, and the peel-off segment.

15. The label of claim 14, further comprising an ink layer disposed in at least the middle segment.

16. The label of claim 11, further comprising a neutralization layer disposed adjacent the second end of the label.

17. The label of claim 11, wherein the at least one void comprises a plurality of voids.

18. The label of claim 17, wherein the at least one void comprises three voids.

19. The label of claim 11, wherein each of the at least one void has a curved triangular shape, the curved triangular shape comprising two curved inner edges, and an outer edge coterminous with the second end of the label.

20. The label of claim 11, wherein a density of the at least one void decreases from the second end to the first end.
